(19) United States
(12) Patent Application Publication
(10) Pub. No.: US 2013/0346297 A1
(43) Pub. Date: Dec. 26, 2013

(54) SYSTEM AND METHOD FOR UNIFIED BILLING

(71) Applicant: One Mainstream, Inc., Saratoga, CA (US)

(72) Inventors: Daniel Zuck, Santa Clara, CA (US); Rajeev Raman, Cupertino, CA (US)

(21) Appl. No.: 13/924,241

(22) Filed: Jun. 21, 2013

Related U.S. Application Data
(60) Provisional application No. 61/662,813, filed on Jun. 21, 2012.

(51) Int. Cl. G06Q 30/04

(52) U.S. Cl. CPC G06Q 30/04
USPC 705/39

(57) ABSTRACT

A system and method for unified billing is herein disclosed. According to one embodiment, the computer-implemented method includes receiving an access to a purchase in an application on a first platform, receiving a request to access the purchase in the application on a second platform, and providing the access to the purchase in the application on the second platform based on the request.

The present application claims the benefit of and priority to U.S. Provisional Patent Application No. 61/662,813 entitled “SYSTEM AND METHOD FOR UNIFIED BILLING” filed on Jun. 21, 2012, the disclosure of which is hereby incorporated by reference in its entirety.

### FIELD

The present disclosure relates in general to the field of electronic billing. In particular, the present disclosure relates to a system and method for unified billing.

### BACKGROUND

The personal computer and the Internet are typical platforms that enable content providers (e.g., content owners, creators, aggregators and advertisers) to publish and deliver content to households en masse. Recently, the emergence of consumer electronic devices with Internet access has created an explosion in the number of new platforms that are available to content providers. For example, these platforms include GOOGLE TV®, GOOGLE® ANDROID®, ROKU®, MICROSOFT® XBOX 360®, SONY® PLAYSTATION 3®, APPLE® IOS®, AMAZON KINDLE FIRE®, and the NINTENDO® WII®.

Content is typically delivered to these platforms as applications that are purchased (or provided for free) and downloaded from an online application store or market (e.g., iTunes and Google Play) by users on their devices. Each online application store supports a particular platform. For example, ITUNES® provided by Apple.Inc is an online application store that provides applications for users to purchase and download onto the APPLE®IOS® platform on their devices. In another example, GOOGLE PLAY® provided by Google.Inc is an online application store that provides applications for users to purchase and download onto the GOOGLE® ANDROID® platform on their devices. Applications refer to software programs that are designed to run on a particular platform. Applications include, but are not limited to, games as well as software for accessing video/audio clips and streaming. After a user downloads an application on his/her device, the user may further make a purchase (e.g., an application, an unlocked feature, additional content, and a subscription) in the application from an application store, or via a website. However, platforms and their respective application stores are typically independent of one another. Thus, a purchase made in an application on one platform is not available in the same application on other platforms. A user using multiple platforms has to repeat a purchase in an application for each platform.

### SUMMARY

A system and method for unified billing is herein disclosed. According to one embodiment, the computer-implemented method includes receiving an access to a purchase in an application on a first platform, receiving a request to access the purchase in the application on a second platform, and providing the access to the purchase in the application on the second platform based on the request.

The above and other preferred features, including various novel details of implementation and combination of events, will now be more particularly described with reference to the accompanying figures and pointed out in the claims. It will be understood that the particular methods described herein are shown by way of illustration only and not as limitations. As will be understood by those skilled in the art, the principles and features described herein may be employed in various and numerous embodiments without departing from the scope of the invention.

### BRIEF DESCRIPTION OF THE DRAWINGS

The accompanying figures, which are included as part of the present specification, illustrate the presently preferred embodiments of the present invention and together with the general description given above and the detailed description of the preferred embodiments given below serve to explain and teach the principles of the present invention.

FIG. 1 illustrates an exemplary process for accessing a purchase in an application across multiple platforms, according to one embodiment.

FIG. 2 illustrates an exemplary architecture for use with the present unified billing system, according to one embodiment.

FIG. 3 illustrates an exemplary process for enabling unified billing across multiple platforms, according to one embodiment.

FIG. 4 illustrates an exemplary user interface for user login, according to one embodiment.

FIG. 5 illustrates an exemplary user interface for making a purchase in an application, according to one embodiment.

FIG. 6(a) illustrates an exemplary user interface for an application during a trial access, according to one embodiment.

FIG. 6(b) illustrates an exemplary user interface for an application after completing a purchase in the application, according to one embodiment.

FIG. 7 illustrates an exemplary user interface that provides a purchase option in an application, according to one embodiment.

FIG. 8 illustrates a block diagram of an exemplary unified billing system, according to one embodiment.

FIG. 9 illustrates another exemplary process for accessing a purchase in an application across multiple platforms, according to one embodiment.

FIG. 10 illustrates an exemplary computer architecture that may be used for the present system, according to one embodiment.

The figures are not necessarily drawn to scale and elements of similar structures or functions are generally represented by like reference numerals for illustrative purposes throughout the figures. The figures are only intended to facilitate the description of the various embodiments described herein. The figures do not describe every aspect of the teachings disclosed herein and do not limit the scope of the claims.

### DETAILED DESCRIPTION

A system and method for unified billing is herein disclosed. According to one embodiment, the computer-implemented method includes receiving an access to a purchase in an application on a first platform, receiving a request to access the purchase in the application on a second platform, and providing the access to the purchase in the application on the second platform based on the request.

Each of the features and teachings disclosed herein can be utilized separately or in conjunction with other features and teachings to provide a system and method for performing the operations described herein. Representative examples utilizing many of these additional features and teachings, both separately and in combination, are described in further detail with reference to the attached figures. This detailed description is merely intended to teach a person of skill in the art further details for practicing preferred aspects of the present teachings and is not intended to limit the scope of the claims. Therefore, combinations of features disclosed above in the detailed description may not be necessary to practice the teachings in the broadest sense, and are instead taught merely to describe particularly representative examples of the present teachings.

In the description below, for purposes of explanation only, specific nomenclature is set forth to provide a thorough understanding of the present disclosure. However, it will be apparent to one skilled in the art that these specific details are not required to practice the teachings of the present disclosure.

Some portions of the detailed descriptions herein are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the below discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk, including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms presented herein are not inherently related to any particular computer or other apparatus. Various general purpose systems, computer servers, or personal computers may be used with programs in accordance with the teachings herein, or it may prove convenient to construct a more specialized apparatus to perform the required method steps. The required structure for a variety of these systems will appear from the description below. It will be appreciated that a variety of programming languages may be used to implement the teachings of the disclosure as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

According to one embodiment, the present system and method uses billing information obtained from one platform and applies it to one or more other platforms. Billing may relate to a purchase in an application, such as a subscription to access content in the application, a purchase of an unlocked feature, and a purchase of an application. According to one embodiment, a content provider publishes content in a custom channel application to multiple specified platforms. A user may make a purchase in an application supported by one platform and further access the same purchase in a corresponding application supported by another platform specified by a content provider. For example, a user purchases a subscription that is valid for a particular time period to access content in an application of one platform. The user may further access the content in a corresponding application of a different platform for the same time period.

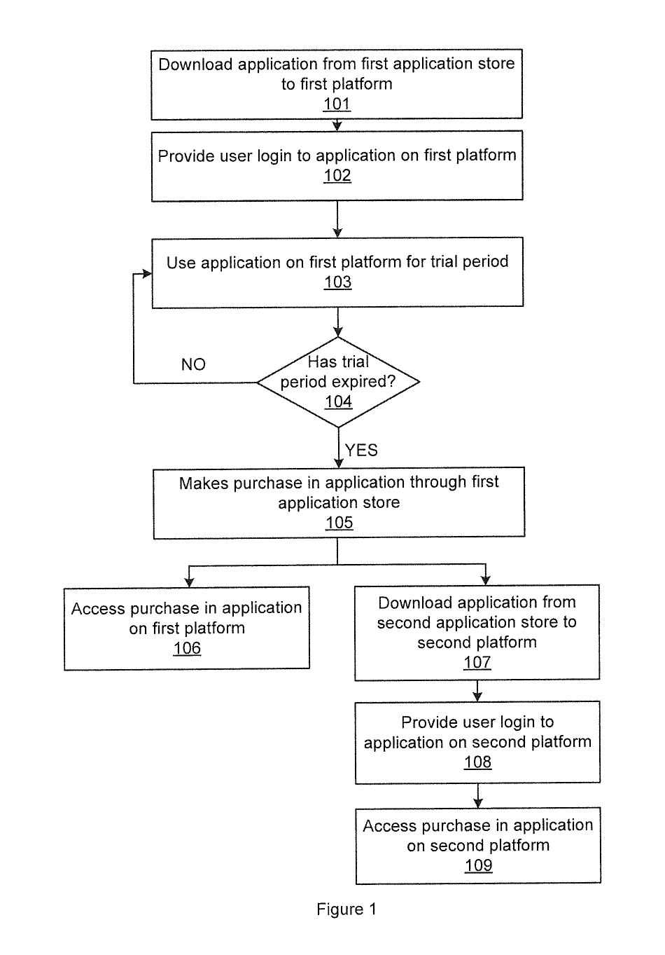

FIG. 1 illustrates an exemplary process for accessing a purchase in an application across multiple platforms, according to one embodiment. A user downloads an application from a first application store to a first platform on a device at 101. After a successful download, the user launches the application on the first platform and provides a user login to the application on the first platform at 102 According to one embodiment, a user provides user login information such as a user ID (e.g., a user name, and an email address) and a password to log into the application via a user interface. According to another embodiment, a user may register a new user account and provide user login information such as a user ID (e.g., user name, and email address) and a password via a user interface of the application. The user may further provide additional user information for the user account including, but not limited to, a first name, a last name, an email address, a gender, and an address. According to another embodiment, a user provides a user login by registering a new user account with a user login from an existing user account associated with a social networking platform (e.g., FACEBOOK®, and GOOGLE+®. According to another embodiment, the user may register a new user login by providing an email address. The application on the first platform forwards validation information (e.g., a URL, and a code) to the user's email address for the user to validate his/her email address.

The user uses the application on the first platform for a trial period at 103. If the trial period expires at 104, the user makes a purchase in the application through the first application store at 105. According to one embodiment, the user purchases a subscription that is valid for one month to access content in the application on the first platform. After the user completes the purchase, the user returns to the application on the first platform and accesses the purchase in the application at 106. Alternatively, the user can download the application from a second application store onto a second platform at 107. After a successful download, the user launches the application on the second platform and provides the same user login (from 102) to the application on the second platform at 108. The user accesses the same purchase in the application on the second platform at 109. According to one embodiment, the user accesses content in the application on the second platform for the same duration of one month.

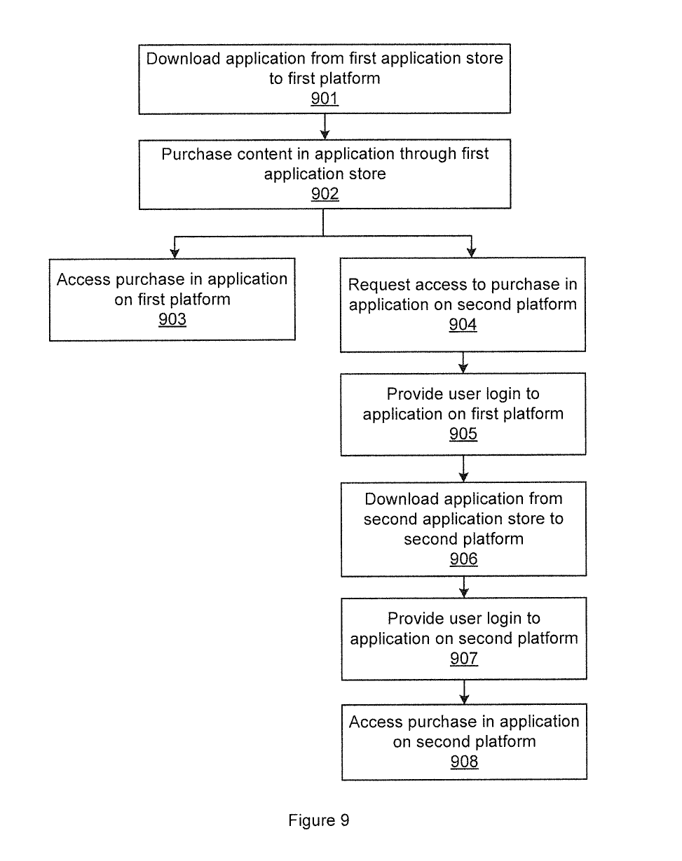

FIG. 9 illustrates another exemplary process for accessing a purchase in an application across multiple platforms, according to one embodiment. A user downloads an application from a first application store to a first platform on a device at 901. After a successful download, the user launches the application on the first platform and makes a purchase in the application through the first application store supporting the first platform at 902. According to one embodiment, the user may have trial access (e.g., a trial period, and a trial content) to the application on the first platform prior to making a purchase. After the user completes the purchase, the user returns to the application on the first platform and accesses the purchase in the application at 903.

Alternatively, the user can request an access to the purchase in a corresponding application on the second platform at 904. According to one embodiment, the application on the first platform displays a link button that allows the user to indicate a request to access the purchase in a corresponding application on the second platform. It is contemplated that the application on the first platform allows the user to indicate a request to access content in a corresponding application on the second platform at various times, including prior to making a purchase, prior to, during, and after a trial access. The user provides a user login to the application on the first platform at 905. According to one embodiment, a user provides user login information such as a user ID (e.g., a user name, and an email address) and a password to log into the application via a user interface. According to another embodiment, a user may register a new user account and provide user login information such as a user ID (e.g., user name, and email address) and a password via a user interface of the application. The user may further provide additional user information for the user account including, but not limited to, a first name, a last name, an email address, a gender, and an address. According to another embodiment, a user provides a user login by registering a new user account with a user login from an existing user account associated with a social networking platform (e.g., FACEBOOK®, and GOOGLE+®). According to another embodiment, the user may register a new user login by providing an email address. The application on the first platform forwards validation information (e.g., a URL, and a code) to the user's email address for the user to validate his/her email address.

The user downloads the application from a second application store onto a second platform at 906. After a successful download, the user launches the application on the second platform and provides the same user login (from 905) to the application on the second platform at 907. The user accesses the same purchase in the application on the second platform at 908.

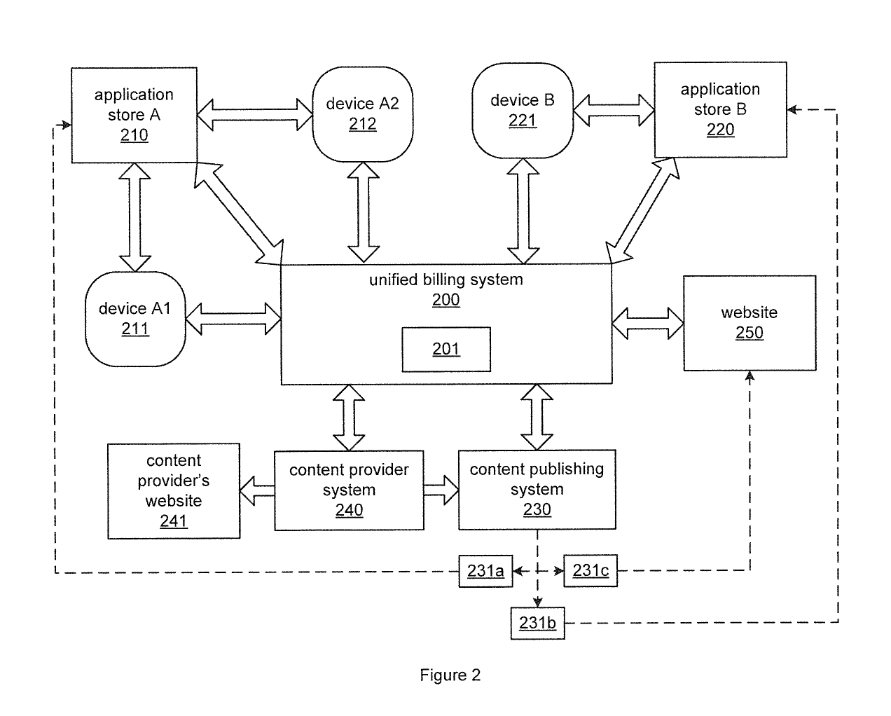

FIG. 2 illustrates an exemplary architecture for use with the present unified billing system, according to one embodiment. A content publishing system 230 receives content from a content provider system 240 and configured settings such as content settings, appearance settings, pricing settings, feature settings, and specified publishing platforms to provide a customized application for each of the specified publishing platforms. The content publishing system 230 provides customized applications 231a, 231b, and 231c for platform A, platform B, and a website respectively. The customized applications 231a, 231b, and 231c provide similar configured settings and similar content received from the content provider system 240. The specified publishing platforms may include, but are not limited to, ROKU® devices, GOOGLE TV®, AMAZON® KINDLE FIRE®, ANDROID® tablets, SAMSUNG SMART TV®, APPLE®IOS® devices, MICROSOFT® XBOX 360®, NINTENDO® WII®, SONY® PLAYSTATION 3®, YOUTUBE®, FACEBOOK®, and various websites. The configured pricing settings may include, but are not limited to, a subscription price for content, a subscription time period, a price for content (e.g., identified by a stock keeping unit (SKU)), and recurring billing for a subscription.

According to one embodiment, the content publishing system 230 provides the customized applications 231a, 231b, and 231c to an application store A 210 supporting platform A, an application store B 220 supporting platform B, and a website 250 respectively. Although FIG. 2 illustrates only two application stores supporting two platforms, it is understood that the present system may support any number of application stores and platforms.

A user having a device A1 211 that supports platform A may download the application 231 from the application store A 210. After successfully downloading and launching the application 231a, the application 231a on the device A1 211 allows the user to provide a user login via a user interface, according to one embodiment. The user provides a user login such as a user ID (e.g., a user name, and an email address) and a password to log into the application. According to one embodiment, the application 231a on the device A1 211 allows the user to register a new user account via the user interface and provide user account information such as a user ID (e.g., user name, and email address) and a password for a user login. The user may further provide additional information for the user account including, but not limited to, a first name, a last name, an email address, a gender, and an address. In another embodiment, the user registers a new user account with a user login from an existing user account on a social networking platform (e.g., Facebook, Google+). In another embodiment, the user registers a new user login by providing an email address. The application 231a on the device A1 211 forwards validation information (e.g., a URL, and a code) to the user's email address for the user to validate his/her email address. The application 231a on the device A1 211 provides the user with a trial access to the content, such as a trial period, and a trial content. The unified billing system 200 receives the user account information and a device ID of the device A1 211 from the application 231a.

According to another embodiment, the application 231a on the device A1 211 provides a trial access to the content in the application 231a without a user login. In this case, the device A1 211 provides the device ID of the device A1 211 to the unified billing system 200 when the user begins a trial access to the content in the application 231. The unified billing system 200 associates the device ID with the trial access in the application 231a on the device A1 211. For example, the unified billing system 200 determines an expiration date/time of a trial period for the application 231a on the device A1 211 based on an epoch time. When the unified billing system 200 determines that the user's trial access to the application 231a on the device A1 211 has expired, the unified billing system 200 provides an API request to the application 231a so that the user interface of the application 231a on the device A1 211 provides the user with options to make a purchase (e.g., an unlocked feature, additional content, a subscription and an application) in the application 231a. If the user chooses to make a purchase in the application 231a, the application 231a on the device A1 211 allows the user to register a new user account prior to making a purchase in the application 231a through the application store A 210. According to one embodiment, the user purchases a one-year subscription that is billed monthly. The process of making a purchase in an application and billing the user may be via a credit card billing process or any other billing process known in the art.

After the user completes the purchase, the application store A 210 forwards a receipt to the application 231a on device A1 211. The receipt provides billing information of the completed purchase including, but not limited to, purchase information, an identifier for the purchase (e.g., a stock-keeping unit (SKU)), a price, a transaction date/time, a transaction ID, an expiration date/time, a platform, an application store information, and a user ID to the application store. The receipt may be in various formats, such as an encrypted/hashed string. The application 231a on the device A1 211 forwards the receipt that includes billing information to the unified billing system 200.

According to one embodiment, the user interface of the application 231a allows the user to indicate a request to access the purchase in the application on other platforms (e.g., an application 231b on platform B). For example, the user interface of the application 231a may display a link button to allow the user to indicate a request to access the purchase with the application on other platforms. If the user selects the link button, the application 231a allows the user to provide a user login to the application 231a.

The unified billing system 200 receives the request and user account information associated with a user login provided by the user. The unified billing system 200 further receives the specified publishing platforms (i.e., platform A, platform B, and the website) and the configured pricing settings for the application 231 from the content publishing system 230.

The unified billing system 200 associates and stores the billing information of the receipt with the corresponding request, including the user account information in a database 201. The unified billing system 200 allows the user account with an access to the purchase in the application 231a on the device A1 211. The unified billing system 200 may further provide a server-to-server communication with the application store A 210 to validate the purchase in the application 231a. The unified billing system 200 further provides the user account with the same access to the purchase in the applications 231b and 231c on the respective platform B and the website 250 based on the billing information.

The user may further download the application 231a into device A2 212 from the application store A 210. After the user launches the application 231a on device A2 212, the application 231a provides a user interface for the user to provide a user login. The user provides the same user login (that is used to log into the application 231a on the device A1 211) to log into the application 231a on the device A2 212. After a successful login, the unified billing system 200 provides the user with the same access to the purchase in the application 231a on the device A2 212. For example, if the user uses a particular user account to purchase a one-month subscription to access content in the application 231a on the device A1 211, the unified billing system 200 grants the same access to that particular user account in the application 231a on the device A2 212 for the same period of time, i.e., one month.

The user may further download the application 231b into device B 221 from the application store B 220. After the user launches the application 231b in device B 221, the application 231b provides a user interface for the user to provide a user login. The user provides the same user login (that is used to log into the application 231a on the device A1 211) to log into the application 231b on the device B 221. After a successful login, the unified billing system 200 provides the user with the same access to the purchase in the application 231b on the device B 221. For example, if the user uses a particular user account to purchase a one-month subscription to access content in the application 231a on the device A1 211, the unified billing system 200 grants the same access to that particular user account in the application 231b on the device B 221 for the same period of time, i.e., one month.

According to one embodiment, the content provider system 240 provides an API request to the unified billing system 200 to receive user account information from the unified billing system 200 into a database of the content provider system 240. The content provider system 240 may provide a GET API request to pull user account information such as a user ID, an application store code, a name, an email address, a gender, a device ID, and an expiration date/time of a subscription.

According to one embodiment, the content provider system 240 provides a content provider's website 241. As described earlier, the user provides a user login to log into the application 231a on the device A1 211, and makes a purchase in the application 231a from the application store A 210. The user may further provide the same user login via a user interface of the content provider's website 241. In this case, the content provider system 240 sends an API request (e.g., a GET API request) to the unified billing system 200 and receives billing information of the purchase of the user account.

According to another embodiment, the user makes a purchase via the content provider's website 241. The unified billing system 200 provides an API request to the content provider system 240 to receive billing information of the purchase from the content provider system 240.

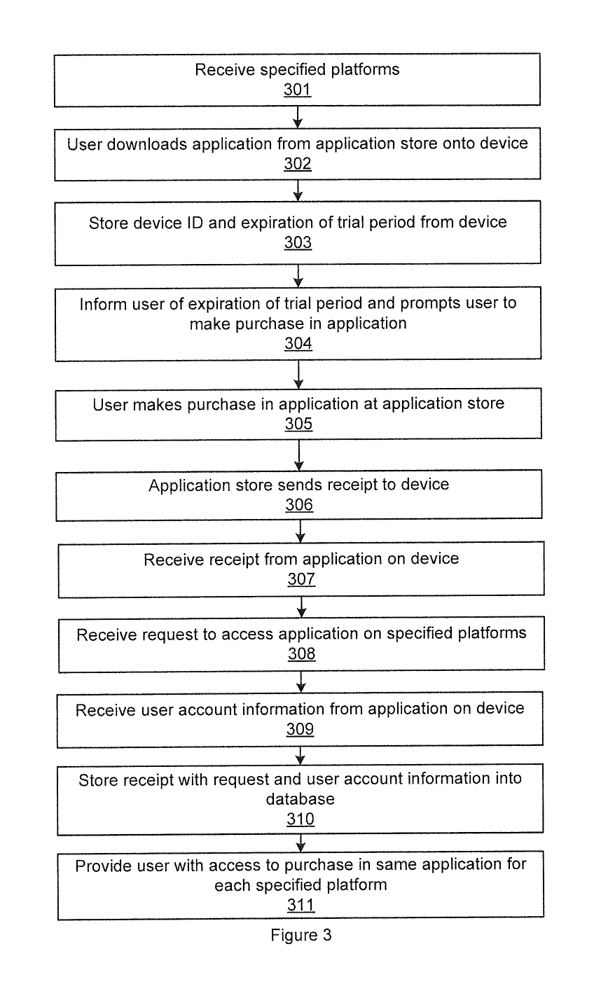

FIG. 3 illustrates an exemplary process for enabling unified billing across multiple platforms, according to one embodiment. The present unified billing system receives specified publishing platforms and pricing settings for an application at 301. According to one embodiment, the present unified billing system receives specified publishing platforms and pricing settings from a content publishing system. The content publishing system provides specified publishing platforms and pricing settings that can be configured by a content provider system. The specified publishing platforms may include, but are not limited to, ROKU® devices, GOOGLE TV®, AMAZON® KINDLE FIRE®, ANDROID® tablets, SAMSUNG SMART TV®, APPLE®IOS® devices, MICROSOFT® XBOX 360®, NINTENDO® WII®, SONY® PLAYSTATION 3®, YOUTUBE®, FACEBOOK®, and various websites. The pricing settings include, but are not limited to, a subscription price for content, a subscription time period, a price for a stocking keeping unit (SKU) of content, and recurring billing for a subscription.

A user downloads the application from an application store onto the device and launches the application at 302. The present unified billing system stores a device ID and an expiration date and time for a trial period received from the device at 303. The expiration date and time for a trial period may be based on an epoch time. The present unified billing system informs the user of the expiration of the trial period and prompts the user to make one or more purchases in the application at 304. The purchases available in the application may be based on the pricing settings configured in the content publishing system. The purchase may include an unlocked feature, additional content, and a subscription (e.g., $9.99 per month) to access content.

The user makes a purchase in the application from the application store at 305. After a successful purchase, the application store sends a receipt to the device at 306. The receipt provides billing information of the purchase including, but not limited to, purchase information, an identifier for the purchase (e.g., a stock-keeping unit (SKU)), a price, a transaction date/time, a transaction ID, an expiration date/time, a platform, and an application store information. The present unified billing system receives the receipt from the application running on the device at 307. The present unified billing system receives a request to access the application on the specified platforms from the application running on the device at 308. According to one embodiment, the user interface of the application running on the device displays a link button that allows the user to indicate a request to access the application on the specified platforms. The present unified billing system further receives user account information from the application running on the device at 309. It is understood that the present unified billing system may receive the request and user account information prior to the user making a purchase at 305. The present unified billing system associates and stores the billing information from the receipt with the request and the user account information in a database at 309. The present unified billing system provides the user with access to the purchase in the same application for each specified publishing platform at 310.

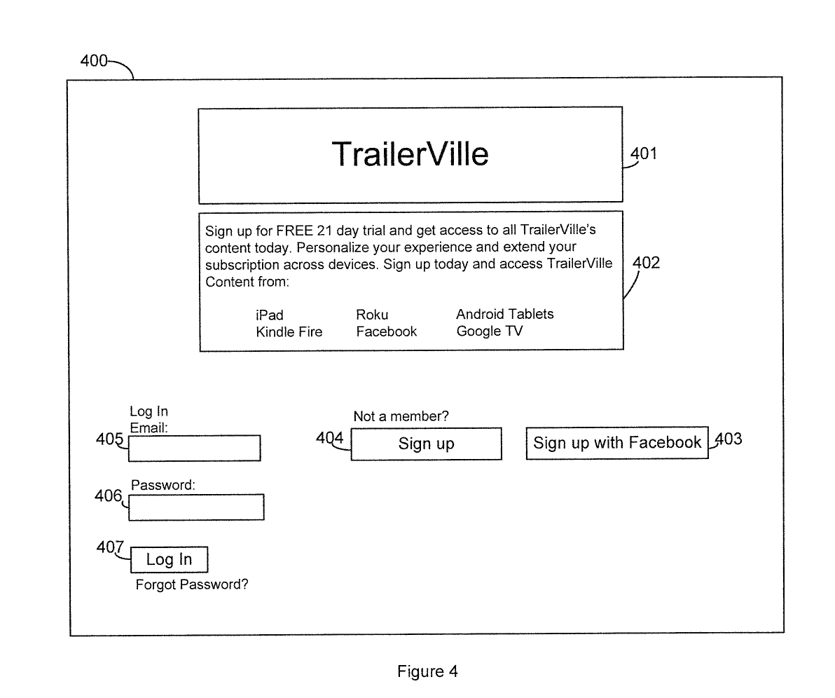

FIG. 4 illustrates an exemplary user interface for user login, according to one embodiment. The user interface 400 includes an application title 401, and application information 402. The application information 402 provides various information regarding the application, such as the trial period, items in the application that are available for purchase (e.g., a subscription), and available platforms to access the application. The user interface 400 allows a user to register a new user account by providing access from an existing account with a social networking platform (e.g., FACEBOOK®, GOOGLE+®), as illustrated by a social network account sign-up button 403. The user interface 400 further allows a user to register a new user account by providing a user ID (e.g., user name, and email address) and password, as illustrated by a sign-up button 404.

If a user has a registered user account, the user interface 400 allows the user to specify user login information, such as an email address 405 and a password 406. The user selects a log in button 407 after specifying the user login information to launch the application. According to one embodiment, the user may specify user login information from a user account with a social networking platform to log into the application.

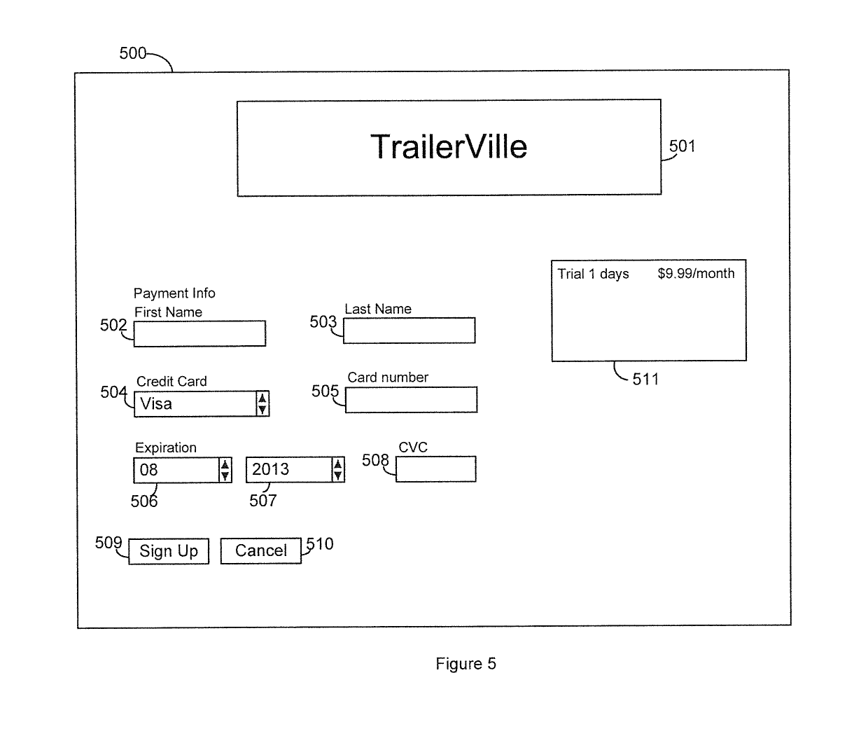

FIG. 5 illustrates an exemplary user interface for making a purchase in an application, according to one embodiment. The user interface 500 includes an application title 501 and pricing information 511 for a purchase in the application. For example, the pricing information for a purchase is a monthly subscription of $9.99. The user interface 500 allows a user to specify payment information, such as a first name 502, a last name 503, a credit card type 504 (e.g., VISA®, MASTERCARD®, and AMERICAN EXPRESS®), a credit card number 505, an expiration month 506, an expiration year 507, and a card verification code (CVC) 508. The user selects a sign-up button 509 after specifying the payment information to make a purchase. The present unified billing system receives and processes the payment information. According to one embodiment, the present unified billing system communicates with an external payment processing system (e.g., STRIPE) to process the payment information. Alternatively, the user may select a cancel button 510 to cancel the purchase.

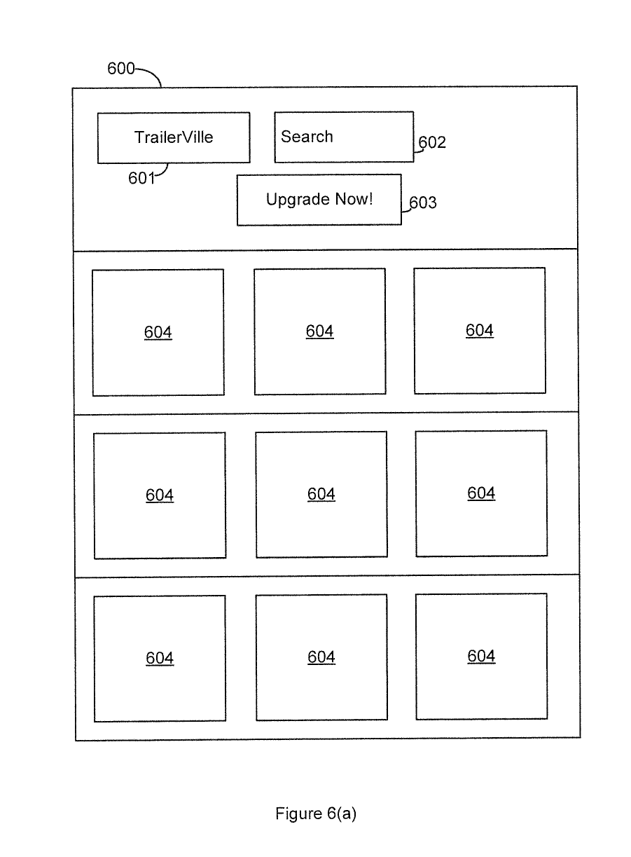

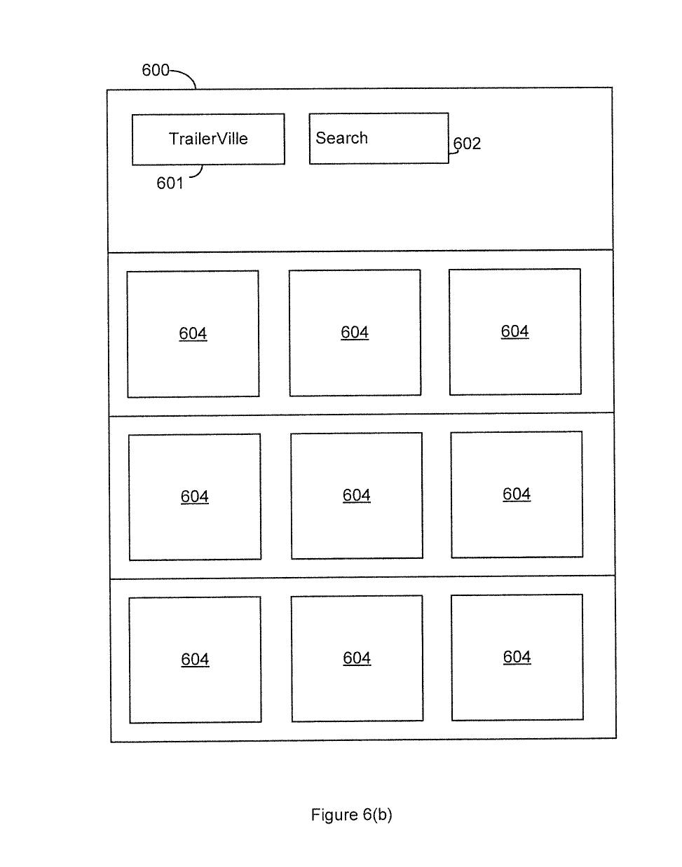

FIG. 6(a) illustrates an exemplary user interface for an application during a trial access, according to one embodiment. The user interface 600 includes an application title 601, a search function 602 and various content files 604. The user interface 600 further includes an upgrade button 603 to prompt a user to make a purchase in the application during a trial access (e.g., a trial period, and a free content) or after the trial access has expired. The upgrade button 603 indicates a selection to make a purchase, including but not limited to, an application, a feature, content, and a subscription. The user may select the upgrade button 603 to initiate a purchase. According to one embodiment, one or more content files 604 may be accessed only after purchase. The user may further select one or more content files 604 to initiate a purchase. The content files 604 that have been purchased may provide a different display (e.g., highlighted, different color, and unmasked) from other content files 604 that have not been purchased, according to one embodiment. FIG. 6(b) illustrates an exemplary user interface for an application after completing a purchase in the application, according to one embodiment. In this case, the upgrade button 603 is removed from the user interface 600 after the user completes a purchase.

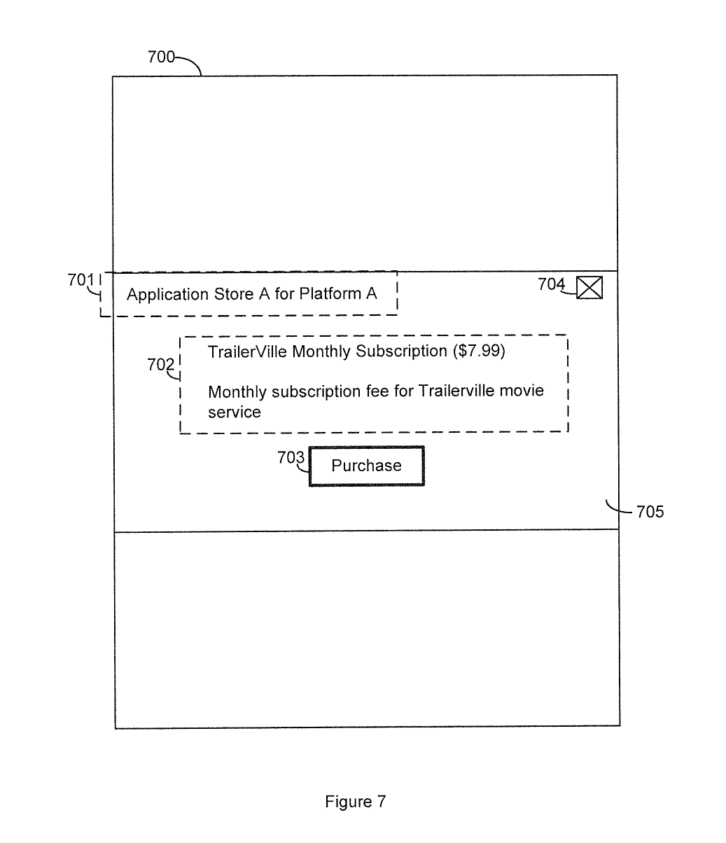

FIG. 7 illustrates an exemplary user interface that provides a purchase option in an application, according to one embodiment. The user interface 700 of an application includes application store information 701 such as an application store name, and a platform the application supports. The user interface 700 further includes purchase information 702 (e.g., a monthly subscription fee of $7.99 to access a movie service of the application). The user may select a purchase button 703 to make a purchase. The user may alternatively select a cancel button 704 to cancel the purchase.

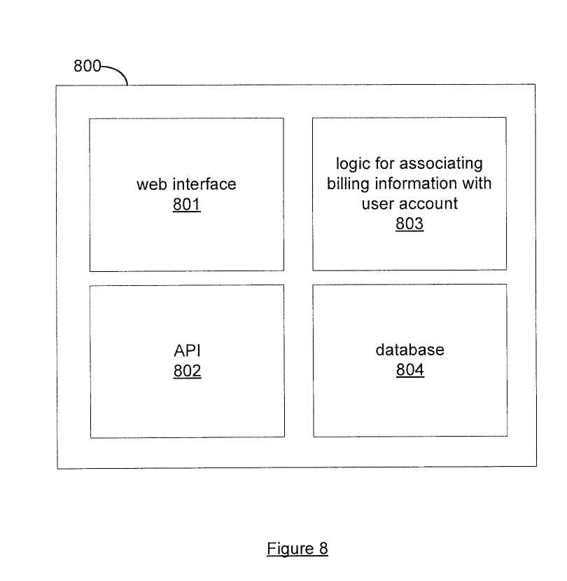

FIG. 8 illustrates a block diagram of an exemplary unified billing system, according to one embodiment. The unified billing system 800 includes a web interface component 801, an application programming interface (API) component 802, a logic component 803 for associating billing information of a purchase in an application with a user account, and a database component 804. It is contemplated that these components may be combined or divided into sub-components, and that the unified billing system 800 or its components may be implemented using software elements, hardware elements, or a combination of software and hardware elements. Such variations are within the scope of the present subject matter.

The web interface component 801 provides a web user interface that allows a user to interact with the present unified billing system 800. In one embodiment, the web interface component 801 allows a user to provide a user login to log into a user account, or to register a new user account, for example, as illustrated in FIG. 4. In another embodiment, the web interface component 801 allows a user to make a purchase in an application, such as purchasing a subscription with a recurring monthly bill to access content in an application, for example, as illustrated in FIG. 5.

The API component 802 provides communication with a device supporting a platform to receive various information, including a device ID, user account information, and a receipt for a completed purchase in an application that is purchased from an application store. The receipt provides billing information of the purchase including, but not limited to, purchase information, an identifier for the purchase (e.g., a stock-keeping unit (SKU)), a price, a transaction date/time, a transaction ID, an expiration date/time, a platform, and an application store information to the application store. The API component 802 may further provide communication with the application store to validate the purchase in the application.

According to one embodiment, the API component 802 provides communication with a content provider system to provide billing information and user account information. The API component 802 may provide an API request to receive billing information of a purchase in an application that is purchased via a web interface of a content provider system. The database component 804 stores billing information of a purchase in an application, user account information, and an association between the billing information for a corresponding user account.

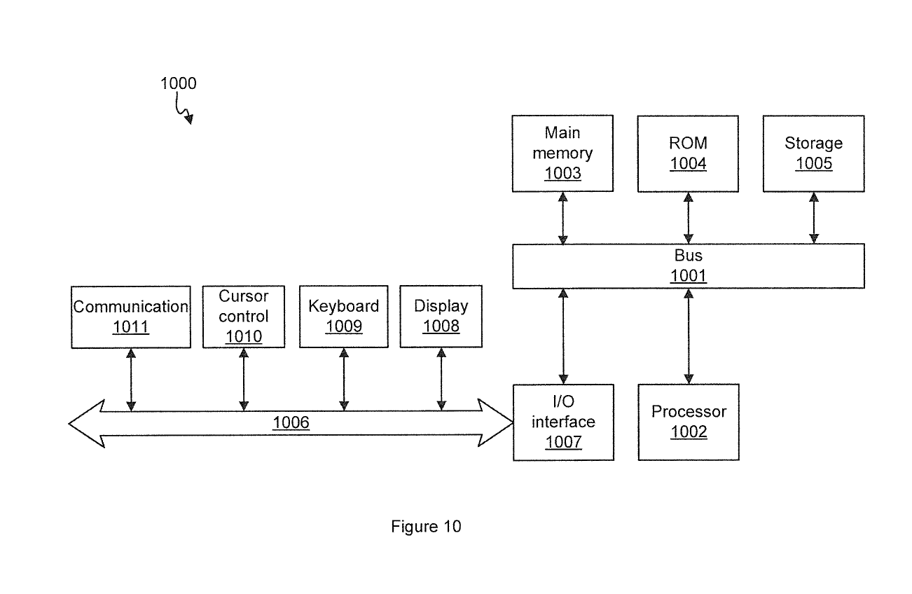

FIG. 10 illustrates an exemplary computer architecture that may be used for the present system, according to one embodiment. The exemplary computer architecture may be used for implementing one or more components described in the present disclosure including, but not limited to, the present system. One embodiment of architecture 1000 includes a system bus 1001 for communicating information, and a processor 1002 coupled to bus 1001 for processing information. Architecture 1000 further includes a random access memory (RAM) or other dynamic storage device 1003 (referred to herein as main memory), coupled to bus 1001 for storing information and instructions to be executed by processor 1002. Main memory 1003 also may be used for storing temporary variables or other intermediate information during execution of instructions by processor 1002. Architecture 1000 may also include a read only memory (ROM) and/or other static storage device 1004 coupled to bus 1001 for storing static information and instructions used by processor 1002.

A data storage device 1005 such as a magnetic disk or optical disc and its corresponding drive may also be coupled to architecture 1000 for storing information and instructions. Architecture 1000 can also be coupled to a second I/O bus 1006 via an I/O interface 1007. A plurality of I/O devices may be coupled to I/O bus 1006, including a display device 1008, an input device (e.g., an alphanumeric input device 1009 and/or a cursor control device 1010).

The communication device 1011 allows for access to other computers (e.g., servers or clients) via a network. The communication device 1011 may include one or more modems, network interface cards, wireless network interfaces or other interface devices, such as those used for coupling to Ethernet, token ring, or other types of networks.

The above example embodiments have been described hereinabove to illustrate various embodiments of implementing a system and method for unified billing. Various modifications and departures from the disclosed example embodiments will occur to those having ordinary skill in the art. The subject matter that is intended to be within the scope of the invention is set forth in the following claims.

We claim:

1. A computer-implemented method, comprising:
receiving an access to a purchase in an application on a first platform;
receiving a request to access the purchase in the application on a second platform; and
providing the access to the purchase in the application on the second platform based on the request.

2. The computer-implemented method of claim 1, wherein receiving the request to access the purchase in the application on the second platform comprises receiving user information.

3. The computer-implemented method of claim 1, wherein providing the access to the purchase in the application on the second platform is based on associating the access to the purchase in the application on the first platform with the request.

4. The computer-implemented method of claim 1, wherein the purchase comprises one or more of the application, an unlocked feature, content, and a subscription.

5. The computer-implemented method of claim 1, further comprising receiving billing information of the purchase in the application from the first platform.

6. The computer-implemented method of claim 5, wherein the billing information comprises one or more of purchase information, an identifier for the purchase, a price, a transaction date, a transaction time, a transaction ID, an expiration date for a subscription, an expiration time for the subscription, the platform, and an application store information.

7. The computer-implemented method of claim 5, wherein the billing information comprises an encrypted string.

8. The computer-implemented method of claim 2, further comprising validating the user information with one of a social networking system, and a content provider system.

9. The computer-implemented method of claim 2, wherein the user information comprises one or more of a user identification, a password, a name, an email address, an address, and a gender.

10. The computer-implemented method of claim 1, further comprising validating the purchase with an application store, wherein the purchase is purchased in the application on the first platform through the application store.

11. The computer-implemented method of claim 2, further comprising providing the user information to a content provider system.

12. The computer-implemented method of claim 5, further comprising providing the billing information to a content provider system.

13. The computer-implemented method of claim 1, further comprising providing a trial access in the application on the first platform, wherein the trial access comprises one or more of a trial period, and a trial content.

14. A non-transitory computer readable medium having stored thereon computer-readable instructions, and a processor coupled to the non-transitory computer readable medium, wherein the processor executes the instructions to:
receive an access to a purchase in an application on a first platform;
receive a request to access the purchase in the application on a second platform; and
provide the access to the purchase in the application on the second platform based on the request.

15. The non-transitory computer readable medium of claim 14, wherein the processor executes the instructions to receive the request to access the purchase in the application on the second platform based on received user information.

16. The non-transitory computer readable medium of claim 14, wherein the processor executes the instructions to provide the access to the purchase in the application on the second platform based on an association between the access to the purchase in the application on the first platform with the request.

17. The non-transitory computer readable medium of claim 14, wherein the purchase comprises one or more of the application, an unlocked feature, content, and a subscription.

18. The non-transitory computer readable medium of claim 14, wherein the processor executes the instructions to receive billing information of the purchase in the application from the first platform.

19. The non-transitory computer readable medium of claim 18, wherein the billing information comprises one or more of purchase information, an identifier for the purchase, a price, a transaction date, a transaction time, a transaction ID, an expiration date for a subscription, an expiration time for the subscription, the platform, and an application store information.

20. The non-transitory computer readable medium of claim 18, wherein the billing information comprises an encrypted string.

21. The non-transitory computer readable medium of claim 15, wherein the processor executes the instructions to validate the user information with one of a social networking system, and a content provider system.

22. The non-transitory computer readable medium of claim 15, wherein the user information comprises one or more of a user identification, a password, a name, an email address, an address, and a gender.

23. The non-transitory computer readable medium of claim 14, wherein the processor executes the instructions to validate the purchase with an application store, wherein the purchase is purchased in the application on the first platform through the application store.

24. The non-transitory computer readable medium of claim 15, wherein the processor executes the instructions to provide the user information to a content provider system.

25. The non-transitory computer readable medium of claim 18, wherein the processor executes the instructions to provide the billing information to a content provider system.

26. The non-transitory computer readable medium of claim 14, wherein the processor executes the instructions to provide a trial access in the application on the first platform, wherein the trial access comprises one or more of a trial period, and a trial content.
